(19) United States
(12) Patent Application Publication
(10) Pub. No.: US 2015/0316877 A1
(43) Pub. Date: Nov. 5, 2015

(54) SHEET CONVEYING APPARATUS AND IMAGE FORMING APPARATUS

(71) Applicant: CANON KABUSHIKI KAISHA, Tokyo (JP)

(72) Inventors: Kazuhisa Okuda, Tokyo (JP); Koji Takematsu, Abiko-shi (JP); Kenjiro Sugaya, Moriya-shi (JP)

(21) Appl. No.: 14/695,284

(22) Filed: Apr. 24, 2015

(30) Foreign Application Priority Data
Apr. 30, 2014 (JP) 2014-093707
Mar. 10, 2015 (JP) 2015-047167

(51) Int. Cl. G03G 15/20; B65H 5/26; B65H 7/20; B65H 5/06

(52) U.S. Cl. CPC G03G 15/2028; B65H 5/068; B65H 5/26; B65H 7/20

(57) ABSTRACT

Provided is a sheet conveying apparatus including: a first pair of rotating members which includes a first rotating member and a second rotating member and conveys a sheet; a second pair of rotating members provided in a downstream side of the first pair of rotating members in a sheet conveying direction and conveys a sheet; a load portion capable of applying a load to rotation of the first pair of rotating members so as to generate a tensile stress onto the sheet when the sheet is nipped by the first pair of rotating members and the second pair of rotating members; and a load transmission path which transmits a load torque according to the load portion to the first rotating member and the second rotating member.

### BACKGROUND OF THE INVENTION

1. Field of the Invention

The present invention relates to a sheet conveying apparatus used in an image forming apparatus such as a copying machine, a printer, and a facsimile, which adopts a method that fixes an unfixed toner image by applying heat and pressure, and an image forming apparatus such as a copying machine, a printer, and a facsimile provided with the sheet conveying apparatus.

2. Description of the Related Art

Hitherto, an image forming apparatus using an electrophotographic system is configured to develop a latent image formed on a photosensitive drum as an image bearing member to be a visible image and to transfer the visible image (toner image) on a sheet using an electrostatic force. Then, the toner image on the sheet is fixed by heat so that an image is recorded and formed on the sheet.

A heat roller fixing method has been employed as a fixing device of such an image forming apparatus, in which a fixing nip portion is formed by causing an elastic pressure roller to press-contact with a fixing roller having a heat source such as a heater therein and being maintained to a predetermined temperature, and a toner image is fixed onto a sheet at the fixing nip portion.

In recent years, in an image forming apparatus (in particular, a full-color image forming apparatus) using such a type of the fixing device, there is known a fixing device capable of increasing a heating time and increasing a fixing speed in terms of improving a chromogenic property or image quality of a toner image. For example, as disclosed in Japanese Patent Laid-Open No. H05-150679, there is known a so-called belt nip type fixing device in which an endless fixing belt stretching around a plurality of rollers is caused to press-contact with a heating roller.

In addition, in recent years, there is a demand for a high process speed so as to obtain a high-speed output image forming apparatus. For this purpose, it is necessary to provide a nip having a wider width in a width direction perpendicular to a sheet conveying direction. Further, a belt fixing method has been proposed and commercially produced, in which a nip having a wider width is secured by substituting any one or both of the fixing roller and the pressure roller with an endless belt (see Japanese Patent Laid-Open No. H05-150679).

However, since heat and pressure are applied to a sheet having a transferred toner image in a heat-fixing process of such a fixing device, moisture inside the sheet is evaporated in a pressed nip portion after a pressed nipping. A change of the moisture amount according to the heat applied to the sheet at this time and a stress according to pressure applied to the sheet cause a phenomenon, that is, a so-called curl by which the sheet is bent, or a phenomenon, that is, a so-called corrugation by which the sheet is undulated.

Here, sheet-like paper, which is most widely employed as a sheet, will be described in a fiber level. Paper is formed by weaving short fibers, and moisture is contained inside fibers or in gaps between fibers. In addition, fibers and water have an equilibrium state while making a hydrogen bonding thereby maintaining flatness.

However, when the heat and pressure are applied to paper in the fixing process, a deviation is caused between the fibers due to the pressure. Further, when the heat is applied in this state so that the moisture is evaporated, another hydrogen bonding is generated between the fibers, and the paper is deformed. If this paper is left as it is, it absorbs moisture from the atmosphere and the hydrogen bonding between the fibers is cut so that the paper tries to return to its original state. However, the moisture is not absorbed into some bonding between the fibers of the paper, and accordingly, the deformation of paper is maintained. A deformation pattern includes a curl and a corrugation as described above. The curl is generated due to an expansion/contraction difference between front and rear of a sheet, and the corrugation is generated due to an expansion/contraction difference between a center portion and an edge portion of a sheet.

A first reason that a corrugation is generated in an edge portion of a sheet is caused in a process that the sheet passes through a nip portion of a fixing device. For example, in the case of a fixing device having a wide nip such as a belt fixing method, a conveyance speed inside a nip portion in an edge side is set to be higher than that in a center portion of a width direction perpendicular to a sheet conveying direction so as to prevent a sheet from being folded while the sheet passes through the nip portion. When an ironing effect is applied to the sheet as a result, the sheet edge portion after passing through the nip portion elongates in the conveying direction relative to the vicinity of the center so that a corrugation is generated in the edge portion of the sheet.

A second reason that the corrugation is generated in the edge portion of the sheet is caused after the sheet passes through the nip portion of the fixing device. In a state where the sheets are loaded in a bundle, each sheet adjoins the atmosphere in the edge portion so that moisture rapidly enters and exits the sheet. If the moisture is rapidly absorbed in the edge portion of the sheet after heat is applied to the sheet in the fixing process, and the moisture inside the sheet is evaporated, the edge portion of the sheet also elongates in the conveying direction relative to the vicinity of the center. As a result, a corrugation is generated in the edge portion of the sheet.

In particular, in a belt fixing method in which a wide nip width is obtained by substituting one or both of a fixing roller and a pressure roller with an endless belt, a distance or time where the sheet stays in the nip increases relative to a heat roller method. Therefore, a corrugation is likely to become significant in the edge portion of the sheet.

### SUMMARY OF THE INVENTION

In this regard, the invention is desirably made to correct a corrugation of a sheet while suppressing a stress on the sheet to the minimum.

A sheet conveying apparatus according to the present invention is desirably includes: a first pair of rotating members which includes a first rotating member and a second rotating member and conveys a sheet; a second pair of rotating members provided in a downstream side of the first pair of rotating members in a sheet conveying direction and conveys a sheet; a load portion capable of applying a load to rotation of the first pair of rotating members so as to generate a tensile stress onto the sheet when the sheet is nipped by the first pair of rotating members and the second pair of rotating members; and a load transmission path which transmits a load torque according to the load portion to the first rotating member and the second rotating member.

According to the present invention, a widthwise center portion of a sheet is elongated in a conveying direction, and a length of the center portion of the sheet and a length of an end portion of the sheet are set to be equal so that it is possible to align the center length of the sheet elongated in the conveying direction to be uniform with the end portion length thereby improving a corrugation in the end portion.

Further features of the present invention will become apparent from the following description of exemplary embodiments with reference to the attached drawings.

### BRIEF DESCRIPTION OF THE DRAWINGS

FIG. 1 is a cross-sectional view illustrating an electrophotographic printer and a sheet corrugation correcting device according to a first embodiment.

FIG. 2 is a top plan view illustrating a spray moistening device according to the first embodiment.

FIG. 3 is a perspective view illustrating the spray moistening device according to the first embodiment.

FIG. 4 is a perspective view illustrating a moistening device, surroundings of a reservoir according to the first embodiment.

FIG. 5 is a block diagram illustrating control of the electrophotographic printer, the moistening device, and a tensioning conveyance device according to the first embodiment.

FIG. 6 is a flowchart illustrating control of the electrophotographic printer, the moistening device, and the tensioning conveyance device according to the first embodiment.

FIGS. 7A and 7B are cross-sectional view illustrating the tensioning conveyance device according to the first embodiment.

FIG. 8 is a top plan view illustrating the tensioning conveyance device according to the first embodiment.

FIG. 9 is a perspective view illustrating a drive configuration of the tensioning conveyance device according to the first embodiment.

FIG. 10 is a perspective view illustrating a drive configuration of the tensioning conveyance device according to the first embodiment.

FIG. 11 is a perspective view illustrating a drive configuration of the tensioning conveyance device according to the first embodiment.

FIG. 12 is an exterior view illustrating a shape of a sheet.

FIGS. 13A and 13B are data tables showing sheet states in experiments.

FIG. 14 is a cross-sectional view illustrating an electrophotographic printer according to a modification of the first embodiment.

FIG. 15 is a block diagram illustrating control of an electrophotographic printer and a sheet corrugation correcting device according to a second embodiment.

FIG. 16 is a cross-sectional view illustrating the electrophotographic printer and the sheet corrugation correcting device according to the second embodiment.

FIG. 17 is a cross-sectional view illustrating a moistening device according to the second embodiment.

FIG. 18 is an exterior perspective view illustrating an end portion of the moistening device according to the second embodiment.

FIG. 19 is a perspective view illustrating surroundings of a reservoir according to the second embodiment.

FIG. 20 is a perspective view illustrating a drive configuration of a tensioning conveyance device according to the second embodiment.

FIG. 21 is a cross-sectional view illustrating a tensioning conveyance device according to a modification of a third embodiment.

### DESCRIPTION OF THE EMBODIMENTS

Hereinafter, exemplary embodiments of the invention will be described in detail with reference to the accompanying drawings. However, dimensions, materials, shapes, relative distributions, and the like of components described in the following embodiments may be appropriately changed depending on a configuration of an apparatus to which the present invention may be employed and various conditions. Accordingly, it is not intended to limit the scope of the invention unless a specified description is provided otherwise.

### First Embodiment

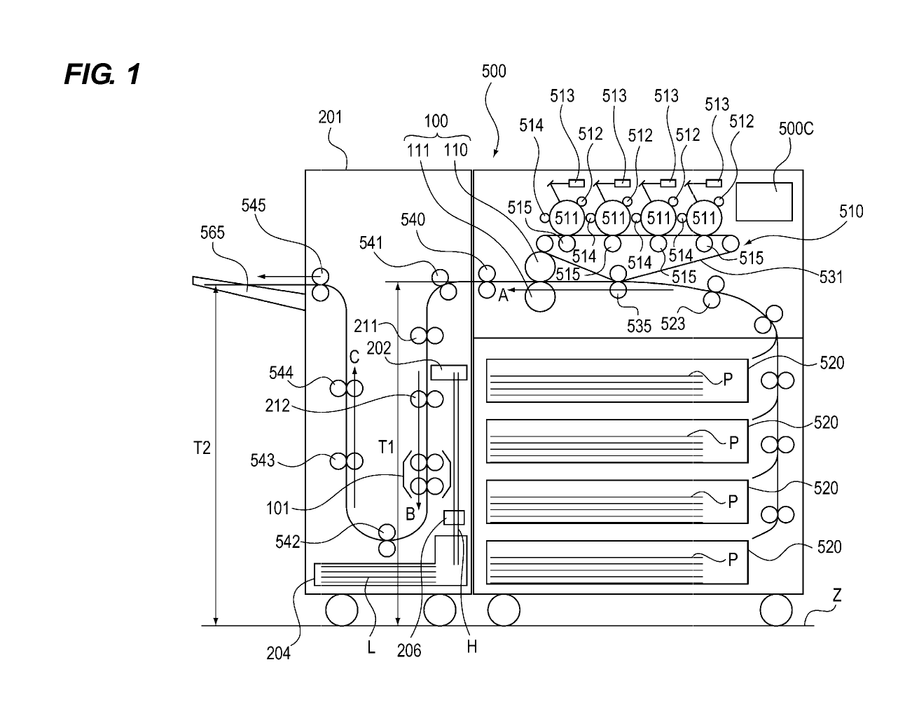

A description will be made regarding on an image forming apparatus provided with a sheet conveying apparatus according to a first embodiment with reference to FIGS. 1 to 14. In the following description, the image forming apparatus will be described first, and the sheet conveying apparatus will be described later. Although the image forming apparatus having the sheet conveying apparatus connected to the exterior thereof will be described in the first embodiment, the invention is also applicable with a configuration of an image forming apparatus having a sheet conveying apparatus incorporated integrally into the inside thereof.

First, the sheet conveying apparatus detachably connected to the image forming apparatus and the image forming apparatus will be described with reference to FIG. 1. FIG. 1 is a cross-sectional view schematically illustrating a color electrophotographic printer 500 as an example of the image forming apparatus, a tensioning conveyance device as an example of the sheet conveying apparatus, and a sheet corrugation correcting device 201 provided with a moistening device, and a cross-sectional view taken along the sheet conveying direction. Incidentally, in the following description, the color electrophotographic printer is simply referred to as a “printer”.

A toner image is formed on a sheet. Specifically, the sheet may include, for example, a plain paper sheet, a resin sheet as a substitute of the plain paper sheet, a thick paper sheet, an overhead projector applicable sheet, and the like.

The printer 500 illustrated in FIG. 1 has an image forming portion 510 for each color of yellow (Y), magenta (M), cyan (C), and black (Bk). In the image forming portion 510 for each color, toner images of each color are formed on a sheet. In addition, an endless intermediate transfer belt 531 as an intermediate transfer member is arranged to face the image forming portion. That is, the image forming apparatus is realized in which a tandem system of executing processes until visualization in parallel for each color is employed.

Incidentally, an arrangement sequence of the image forming portions for each color of Y, M, C, and K is not limited to that illustrated in FIG. 1. In addition, the embodiment may also be applicable to a monochromatic image forming apparatus without limiting to a full-color intermediate transfer type image forming apparatus of FIG. 1.

In the image forming portion 510 for each color, each processing portion is provided as follows. For each color of Y, M, C, and K, an electrophotographic photosensitive element (hereinafter, referred to as a photosensitive drum) 511 as an image bearing member for bearing an electrostatic latent image on a surface, a charging roller 512, a laser scanner 513, and a development device 514 are provided. The photosensitive drum 511 is charged by the charging roller 512 in advance. Then, the photosensitive drum 511 is exposed by the laser scanner 513 to form a latent image. The latent image is developed by the development device 514 and is visualized as a toner image.

In a primary transfer portion including the photosensitive drum 511 and a primary transfer roller 515, each toner image formed and born on a surface of the photosensitive drum 511 is primarily transferred onto an intermediate transfer belt 531 by the primary transfer roller 515 in a sequentially superimposed manner.

Meanwhile, sheets P are fed from a sheet cassette 520 one by one to a pair of registration rollers 523. The pair of registration rollers 523 once receives the sheet P and corrects a skew in the case of skew feeding. In addition, the pair of registration rollers 523 feeds the sheet P to a secondary transfer portion between the intermediate transfer belt 531 and a secondary transfer roller 535 in synchronization with the toner image on the intermediate transfer belt 531. The color toner images on the intermediate transfer belt 531 are secondarily transferred onto the sheet P, for example, by the secondary transfer roller 535 as a transfer portion in a collective manner.

Then, the sheet on which the image (toner image) is formed by the image forming portion as described above is conveyed to a fixing device 100. In the fixing device (fixing portion) 100, the toner image on the sheet is fixed by applying heat and pressure to the unfixed toner image by nipping the sheet in a fixing nip portion. The sheet after passing through the fixing device 100 is fed by a pair of discharge rollers 540 to a sheet corrugation correcting device 201 as a sheet processing apparatus of processing the sheet. Then, the corrugation on the sheet is corrected by the sheet corrugation correcting device 201, and thereafter, the sheet is discharged to a discharge tray 565.

Here, the fixing device will be described. The fixing device 100 is provided with a fixing roller 110 as a heating rotating member and a pressure roller 111 as a pressing rotating member. The fixing roller 110 applies heat generated by an internal halogen heater (not illustrated) to a toner on the sheet P and conveys the sheet P in cooperation with the pressure roller 111. The fixing roller 110 has a halogen heater embedded into a metal core made of an aluminum cylindrical tube, for example, having an outer diameter of 56 mm and an inner diameter of 50 mm. An elastic layer made of a silicon rubber, for example, having a thickness of 2 mm and a hardness of 45° (Asker-C) is coated on a surface of the metal core, and a heat-resistant toner parting layer made of perfluoroalkoxy (PFA) or polytetrafluoroethylene (PTFE) is further coated on a surface of the elastic layer.

The pressure roller 111 conveys the sheet P in cooperation with the fixing roller 110. The pressure roller 111 also has a metal core made of an aluminum cylindrical tube, for example, having an outer diameter of 56 mm and an inner diameter of 50 mm. An elastic layer made of a silicon rubber, for example, having a thickness of 2 mm and a hardness of 45° (Asker-C) is coated on a surface of the metal core, and a heat-resistant toner parting layer made of PFA or PTFE is further coated on a surface of the elastic layer.

The fixing nip portion is formed by the fixing roller 110 and the pressure roller 111. In an experiment of the inventors, a conveyance speed of the sheet P is set to about 300 to 500 mm/sec assuming a condition that a surface setting temperature of the fixing roller 110 is 180° C., a surface setting temperature of the pressure roller 111 is 100° C., an atmospheric temperature is 23° C., and an atmospheric humidity is 50%. The sheet P heated and pressed in the fixing nip portion N receives more heat generated from the fixing roller 110 at higher temperature than the pressure roller 111, and fibers thereof elongate such that the upper surface of the sheet P elongates more than the lower surface. As a result, a curl downward (hereinafter, referred to as a downward curl) is generated. Alternatively, in the sheet P heated and pressed in the fixing nip portion N, the fibers thereof elongate such that the edge side of the sheet P of a width direction perpendicular to the sheet conveying direction elongates more than the center side. As a result, an edge corrugation (hereinafter, referred to as a corrugation) is generated.

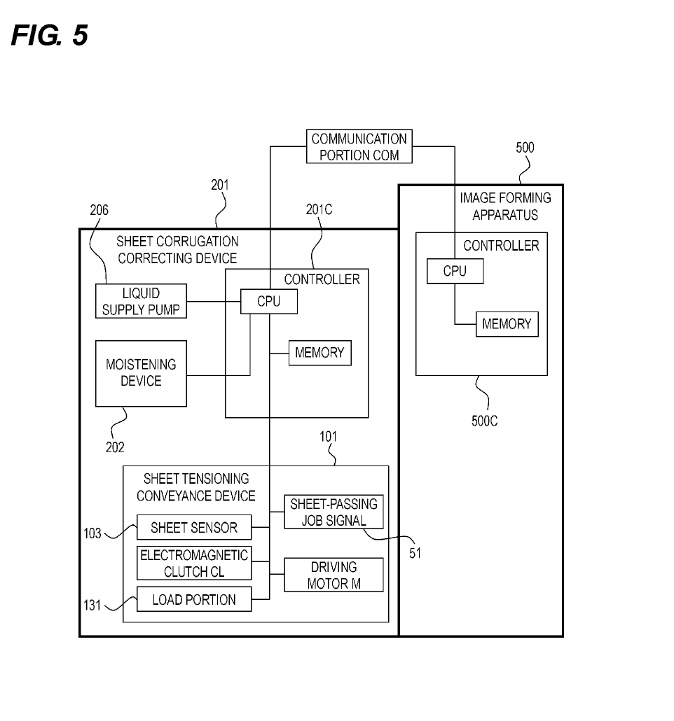

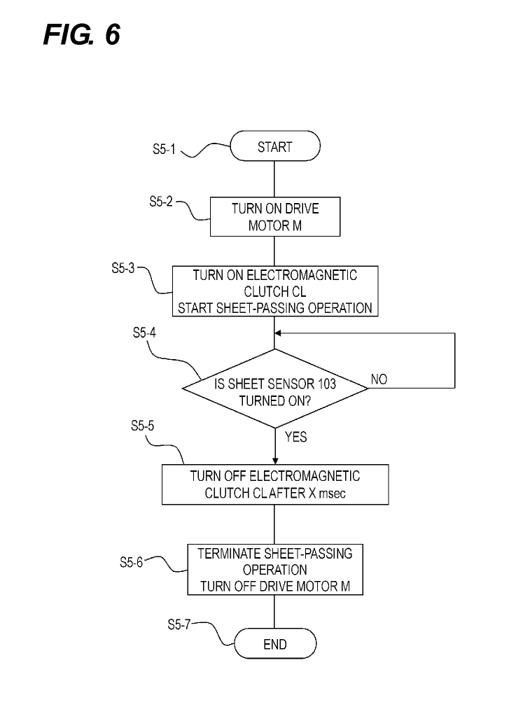

Here, a control relationship in the entire image forming apparatus and the sheet corrugation correcting device will be described with reference to FIG. 5. FIG. 6 is a block diagram illustrating a control relationship in an entire image forming apparatus 500 and the sheet corrugation correcting device 201. A controller 500C of the image forming apparatus 500 and a controller 201C of the sheet corrugation correcting device 201 are computer systems having a central processing unit (CPU), a memory, an operational unit, an input/output (I/O) port, a communication interface, a driving circuit, and the like.

The control operations of each controller 500C and 201C described above are performed by causing the CPU to execute a predetermined program stored in the memory. The controller 201C of the sheet corrugation correcting device 201 controls the operations of a sheet moistening device 202 and a sheet tensioning conveyance device 101 included in the apparatus. In addition, the controllers 500C and 901C described above are connected to each other using a communication portion COM to exchange information.

Incidentally, in the drawing, a description regarding on a block which is not directly related to the description of the present invention is omitted. In addition, here, a configuration is exemplified in which the operation of the sheet corrugation correcting device 201 is controlled by controlling the controller 201C included in the sheet corrugation correcting device 201 by the controller 500C included in the image forming apparatus 500, but it is not limited thereto. For example, it may be configured such that the operation of the sheet corrugation correcting apparatus is controlled by a controller included in the printer instead of providing the controller in the sheet corrugation correcting apparatus.

The sheet P having a toner image fixed by the fixing device 100 is fed to a sheet corrugation correcting device 201 by a pair of discharge rollers 540. The sheet P is conveyed by a pair of entrance rollers 541 of the sheet corrugation correcting device 201 in an arrow direction A indicated in FIG. 1. Further, the conveyance direction of the sheet P is changed to a vertically downward direction (arrow direction B in FIG. 1). Then, the sheet P is moistened while passing through the sheet moistening device 202 as the moistening device when being conveyed from a pair of conveying rollers 211 to a pair of conveying rollers 212.

The sheet P after passing through the pair of conveying rollers 212 is subsequently fed to the sheet tensioning conveyance device 101 as a conveyance unit. The sheet P is moistened at a predetermined moisture amount or more by the sheet moistening device 202 and then passes through the sheet tensioning conveyance device 101. A length difference in the sheet conveying direction between the widthwise center portion and the widthwise edge portion is reduced by pulling a center portion of the width direction perpendicular to the sheet conveying direction in the conveying direction.

In this manner, the sheet P in which the corrugation is corrected in the widthwise edge portion of the sheet is discharged to the outside of the sheet corrugation correcting device 201 by pairs of conveying rollers 542, 543, 544 and 545, and then is loaded on a discharge tray 565.

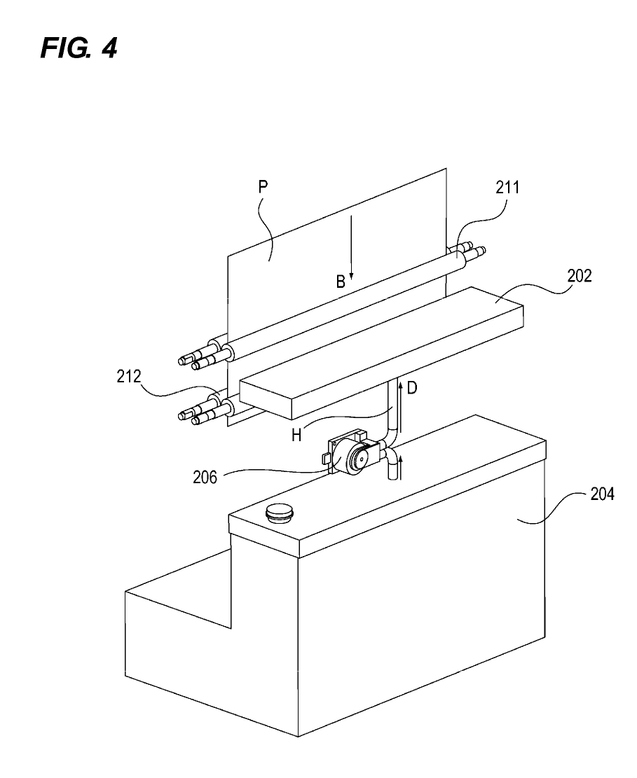

FIG. 4 illustrates a structure surrounding the pair of conveying rollers 211, the pair of conveying rollers 212, the sheet moistening device 202, a reservoir 204, and a liquid supply pump 206.

The reservoir 204 is a storage member in which a moistening liquid L for moistening the sheet P is stored. The moistening liquid L stored in the reservoir 204 passes through a liquid supply pipe H and is occasionally supplied in arrow D direction indicated in FIG. 4 toward the sheet moistening device 202 by the liquid supply pump 206. The moistening liquid L contains water as a main component and may also contain a surfactant in consideration of moistening efficiency or a penetration capability to the sheet P.

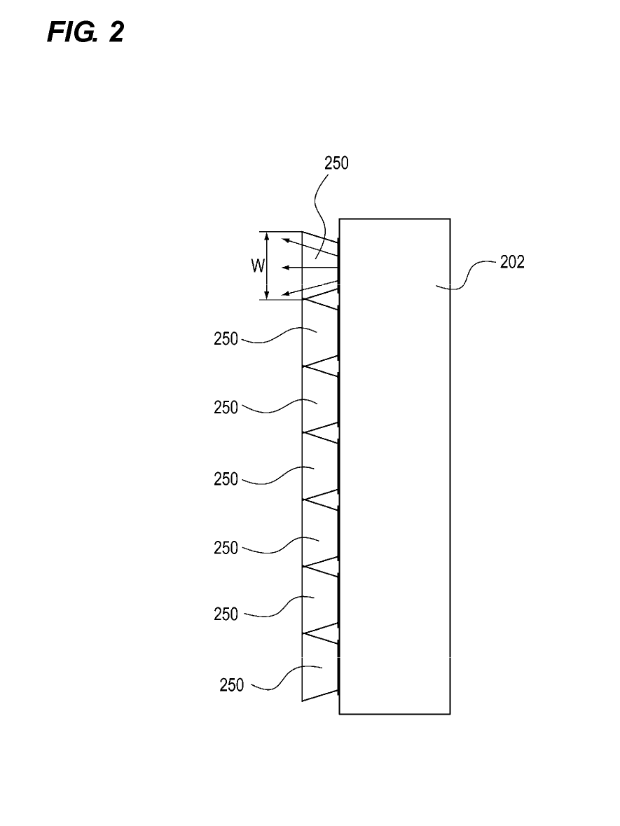

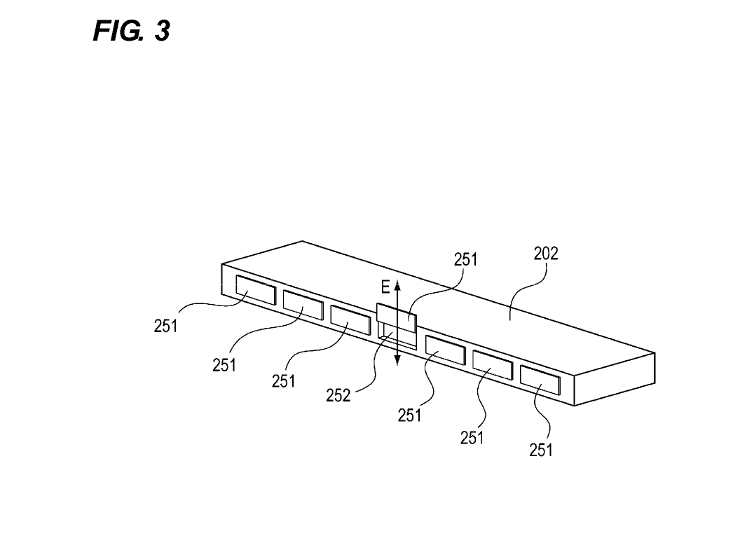

Next, the sheet moistening device 202 will be described with reference to FIGS. 2 and 3. FIG. 2 is a top plan view illustrating the sheet moistening device 202, and FIG. 3 is a perspective view illustrating the sheet moistening device 202. Here, as the sheet moistening device 202, a spray moistening device that sprays a liquid in a mist state is exemplarily described.

As illustrated in FIG. 3, a plurality of spray nozzles 252 for spraying the moistening liquid L in a mist state is opened in a surface of the sheet moistening device 202 facing the sheet P. The plurality of spray nozzles 252 is arranged side by side in the sheet width direction. In response to an instruction from the controller 201C (see FIG. 5), the sheet moistening device 202 sprays the moistening liquid L in a fan shape and a mist state along an arrow direction 250 in FIG. 2 to the sheet P. In FIG. 2, each fan-shaped spray width on a surface of the sheet P is denoted by W. However, a width, an interval, and a spray angle of the spray nozzle 252 are set such that spray widths (spray areas) of neighboring spray nozzles 252 to the sheet are slight overlapped with each other. For this reason, the moistening liquid L is sprayed onto the surface of the sheet P without a gap in the width direction for moistening.

A shutter 251 illustrated in FIG. 3 is an opening and closing member that opens or closes each spray nozzle 252 of the sheet moistening device 202. In response to an instruction from the controller 201C (see FIG. 5), the shutter 251 reciprocates in an arrow direction E of FIG. 3 to open or close each spray nozzle 252 and switch a spray and non-spray state of the moistening liquid L so that the moistening liquid L is sprayed onto a necessary area, only.

Any device may be employed as the sheet moistening device 202, and for example, a rotor dampening device manufactured by Weitmann & Konrad GmbH & Co. KG may be suitably employed. However, the sheet moistening device 202 according to this embodiment is not limited to the rotor dampening device described above. Various types of devices capable of spraying may be employed. For example, a device having a plurality of shower nozzles in a width direction and capable of spraying a liquid only to a necessary portion may also be employed.

Next, the sheet tensioning conveyance device 101 will be described with reference FIGS. 5 to 13. The sheet tensioning conveyance device 101 is provided with plural pairs of rotating members that applies a tensile strength (tensile stress) for elongating the widthwise center portion of the sheet P guided into a portion between an inlet guide 102 and an inlet guide 121 after passing through the above-described moistening device 202, in the conveying direction.

Here, a first pair of rollers (first pair of rotating members) and a second pair of rollers (second pair of rotating members) provided at downstream side in the conveying direction than the first pair of rollers to be described hereinafter are exemplified as the plural pairs of rotating members. Incidentally, the first pair of rollers or the second pair of rollers may be configured by a pair of belts instead of rollers.

The first pair of rollers includes a rotatable first drive roller 104 as a first roller, and a first pressure roller 105 as a second roller which is pressed against the first drive roller 104 to form a first nip portion N1, and nips and conveys the sheet P.

The second pair of rollers is provided at the downstream side in the conveying direction than the first pair of rollers. The second pair of rollers includes a rotatable second drive roller 106 as a third roller, and a second pressure roller 107 as a fourth roller which is pressed against the second drive roller 106 to form a second nip portion N2, and nips and conveys the sheet P.

The sheet tensioning conveyance device 101 is configured to nip and convey the sheet P by the first drive roller 104 and the first pressure roller 105 forming the first pair of rollers, and the second drive roller 106 and the second pressure roller 107 forming the second pair of rollers. The sheet tensioning conveyance device 101 is further configured to apply the tensile strength to the sheet P so as to elongate the widthwise center portion of the sheet P in the conveying direction while conveying the sheet P. In addition, the sheet P is guided into a portion between an outlet guide 117 and an outlet guide 118 to be discharged to the outside of the sheet tensioning conveyance device 101.

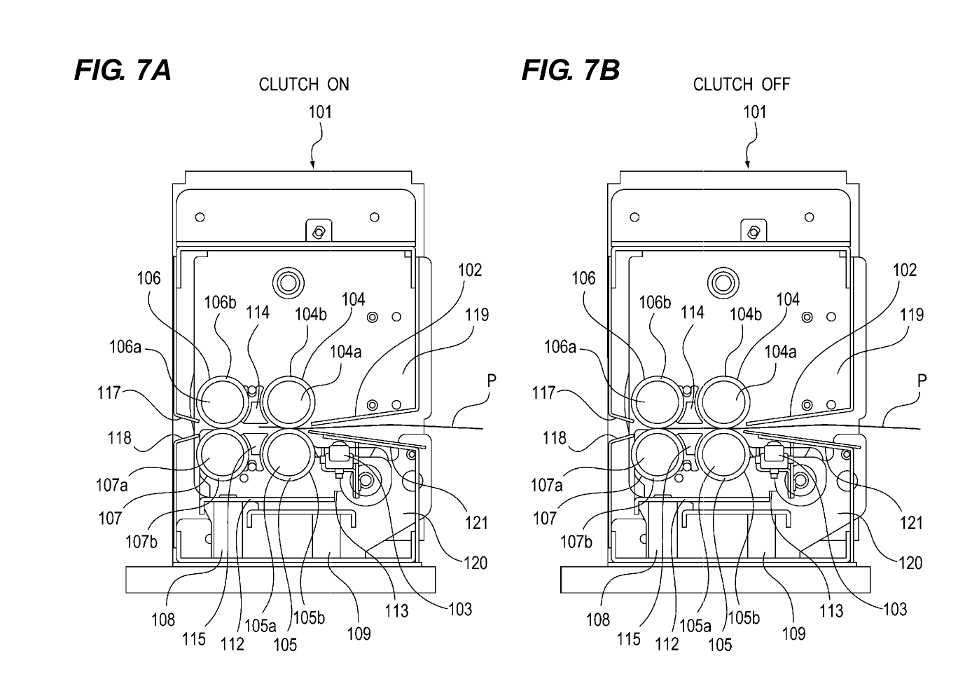

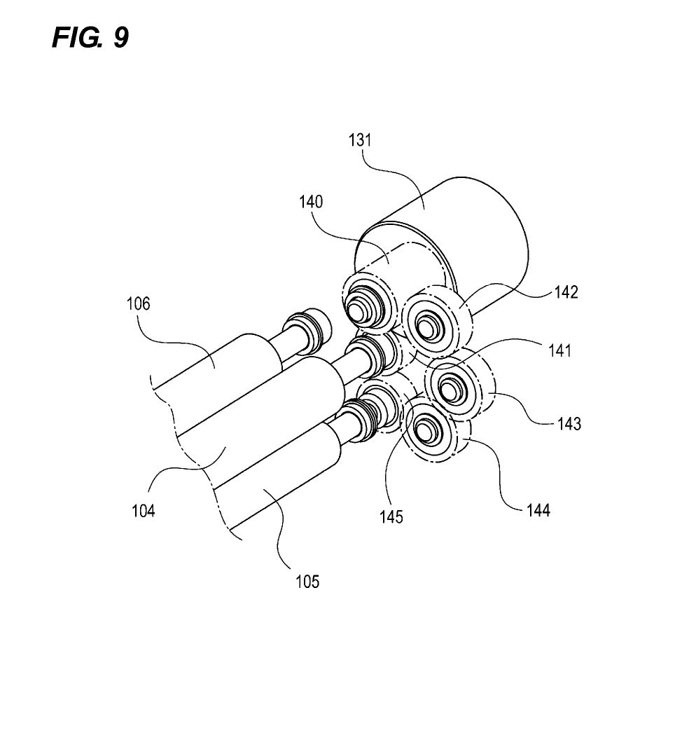

The first drive roller 104, the first pressure roller 105, the second drive roller 106, and the second pressure roller 107 have elastic rubbers 104b, 105b, 106b, and 107b, respectively, made of silicon, nitrile butadiene rubber (NBR), ethylene propylene diene monomer (EPDM), or the like as illustrated in FIGS. 7A and 7B. The elastic rubbers 104b, 105b, 106b, and 107b are formed on surfaces of roller shafts 104a, 105a, 106a, and 107a, respectively, made of a high rigidity material such as stainless steel or iron steel. In this embodiment, each outer diameter of the elastic rubbers 104b, 105b, 106b, and 107b is set to 20 mm. In addition, as illustrated in FIGS. 7A and 7B, the elastic rubbers 105b and 107b of the first and second pressure rollers 105 and 107 are formed in an area having a length L1 in the sheet widthwise center portion so as to be symmetrical with respect to a sheet passage center. Here, the sheet passage center refers to a position of the widthwise center serving as a reference when a sheet is conveyed. The length L1 is set to be shorter than the maximum widthwise length (widthwise length of a sheet having a predetermined size) of the sheet P that makes a corrugation trouble as illustrated in FIG. 9. In this embodiment, the length L1 is set to 100 mm. The sheet having a predetermined size is a sheet having a size that the apparatus uses with a high frequency, and an example thereof is a sheet of A3 size (297 mm). In this manner, the elastic rubbers 105b and 107b are disposed in the widthwise center. Accordingly, the first drive roller 104 and the first pressure roller 105 forms the nip portion in the widthwise center thereof.

Incidentally, in this embodiment, an elastic rubber portion is provided in the widthwise center of the first pressure roller 105 and the second pressure roller 107, but it is not limited thereto. The elastic rubber portion may be provided in the widthwise center of the first drive roller 104 and the second drive roller 106.

In addition, a conveyance guide 114 and a conveyance guide 115 as a guiding member for guiding a sheet are provided between the nip portions of the first pair of rollers and the second pair of rollers, and a distance between the nip portions is set to 25 mm.

Both ends of the roller shafts 104a and 106a of the first drive roller 104 and the second drive roller 106, respectively, are supported by an upper side plate 119 of using a bearing (not illustrated).

Both ends of the roller shaft 105a of the first pressure roller 105 are supported by a first compression plate 113 using a bearing (not illustrated). The first compression plate 113 is rotatably supported by a lower side plate 120 using a first rotational shaft (not illustrated), and a bottom surface thereof is biased by a first pressure spring 109. As a result, the first pressure roller 105 is pressed to the first drive roller 104 to form the first nip portion N1.

Both ends of the roller shaft 107a of the second pressure roller 107 are supported by a second compression plate 112 using a bearing (not illustrated). The second compression plate 112 is rotatably supported by the lower side plate 120 using a second rotational shaft (not illustrated), and a bottom surface thereof is biased by a second pressure spring 108. As a result, the second pressure roller 107 is pressed to the second drive roller 106 to form the second nip portion N2.

As illustrated in FIGS. 7A and 7B, a reflection light type sheet sensor 103 that detects arrival of the sheet P is arranged in the inlet guide 121.

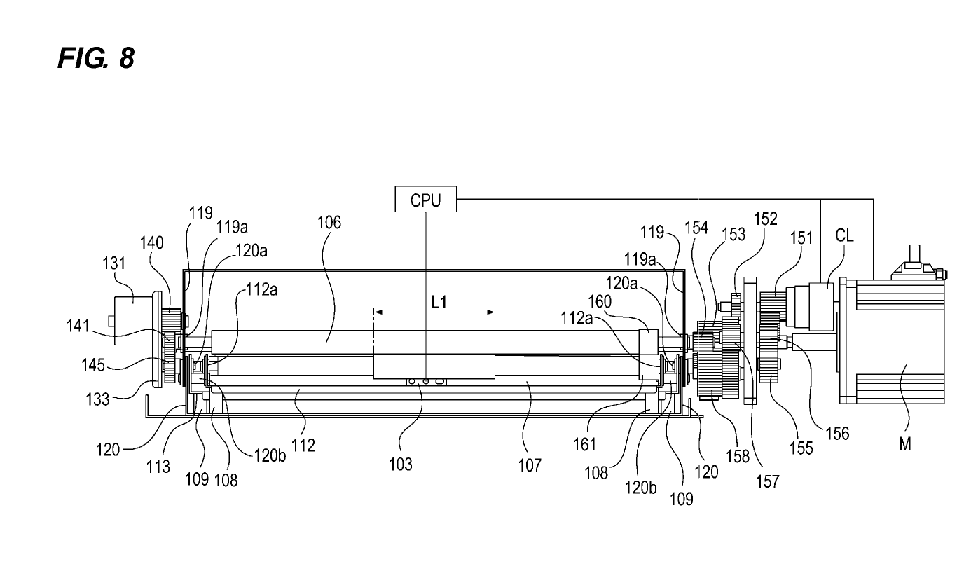

FIG. 8 is a top plan view illustrating a driving mechanism and a torque loading mechanism of the first drive roller 104, the first pressure roller 105, the second drive roller 106 and the second pressure roller 107. FIGS. 9 to 11 are perspective views illustrating the driving mechanism and torque loading mechanism of the first drive roller 104, the first pressure roller 105, the second drive roller 106 and the second pressure roller 107.

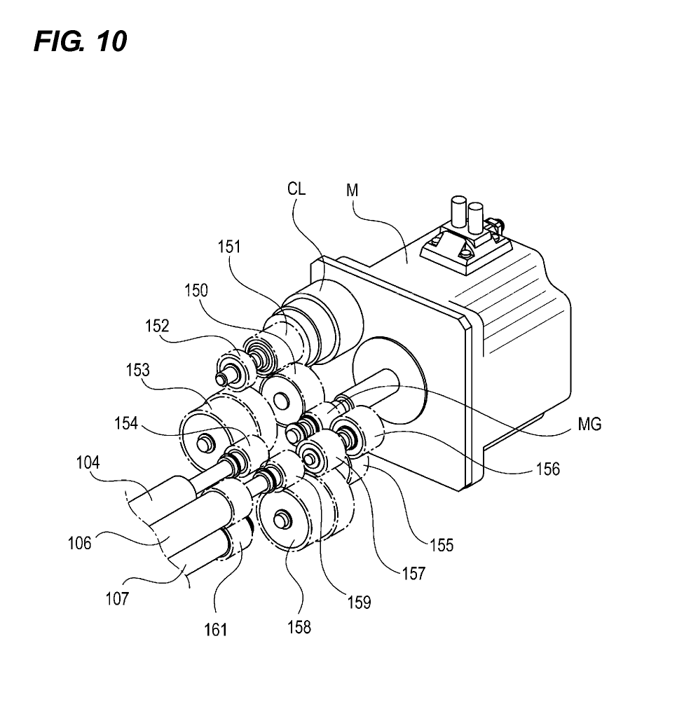

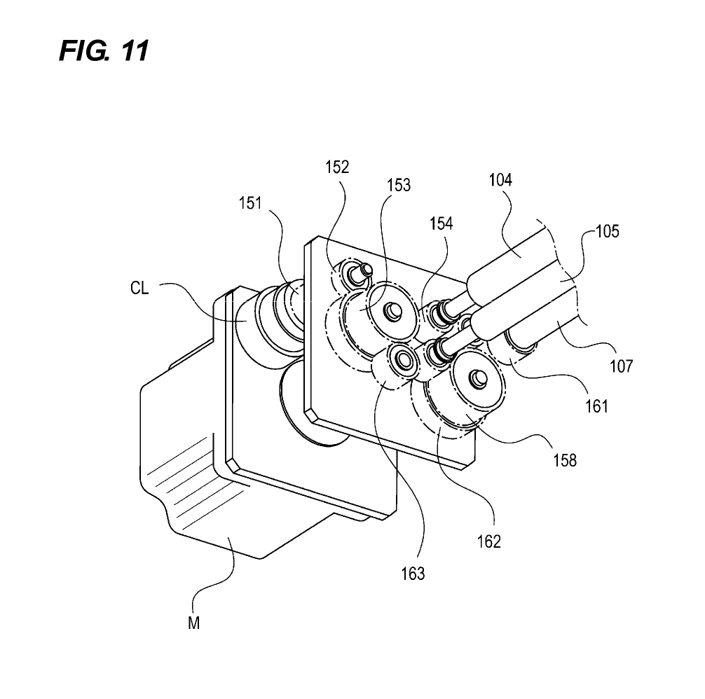

As illustrated in FIGS. 10 and 11, drive gears 154, 159 and 162 are held and fixed in respective one end of the first drive roller 104, the second drive roller 106 and the first pressure roller 105. The first drive roller 104 is rotated by a drive gear 154 receiving a rotational driving force from a motor gear MG of a drive motor M serving as a drive source via a drive transmission gear 150, a clutch input gear 151 of an electromagnetic clutch CL, a clutch output gear 152, and a drive transmission gear 153.

Similarly, the second drive roller 106 is rotated by a drive gear 159 receiving a rotational driving force from the motor gear MG of a drive motor M via drive transmission gears 155, 156, 157 and 158. Similarly, the first pressure roller 105 is rotated by a drive gear 162 receiving a rotational driving force via a drive transmission gear 163 connected being branched from the drive transmission gear 153.

As illustrated in FIG. 10, a drive transmission gear 160 to transmit a driving force from the second drive roller 106 to the second pressure roller 107, and a drive input gear 161 engaged with the drive transmission gear 160 are held and fixed in the second drive roller 106 and the second pressure roller 107, respectively. Accordingly, both the second drive roller 106 and the second pressure roller 107 receive a rotational driving force to frictionally convey the sheet P from the front and rear side thereof.

The clutch input gear 151 is fixed to the electromagnetic clutch CL, and a connection for transmitting a driving force is made between the clutch input gear 151 and the clutch output gear 152 as electricity flows through the electromagnetic clutch CL. Meanwhile, if electricity does not flow to the electromagnetic clutch CL, a driving force is not transmitted between the clutch input gear 151 and the clutch output gear 152, the driving force of the drive motor M is not transmitted to the drive gear 154 and the drive gear 162 so that the first drive roller 104 and the first pressure roller 105 are not rotated.

As illustrated in FIG. 9, a load torque input gear 141 is fixed to the other end of the first drive roller 104, and is connected to a load torque generation member 131 such as an electromagnetic brake through a load torque transmission gear 140.

Similarly, a load torque input gear 145 is fixed to the other end of the first pressure roller 105, and is connected to the load torque generation member 131 such as an electromagnetic brake through load torque transmission gears 144, 143, 142 and 140.

Here, a load portion generating the load torque has the load torque generation member 131 and the load torque transmission gear 140. The load torque generation member 131 is a member of generating a load torque such as an electromagnetic brake. In addition, the load torque transmission gear 140 is a branching gear causes the load torque to branch into a first path lead to the first drive roller 104 as the first roller and a second path lead to the first pressure roller 105 as the second roller.

The load portion is arranged on a load transmission path of transmitting the load torque generate by the load torque generation member 131 to the first drive roller 104 as the first roller and the first pressure roller 105 as the second roller. The load transmission path which transmits the load torque generated by the load torque generation member 131 to the first drive roller 104 is the first path, and corresponds to a gear train lead to the first drive roller 104 from the load torque generation member 131 in this embodiment. In addition, a load transmission path which transmits the load torque generated by the load torque generation member 131 to the first pressure roller 105 is the second path, and corresponds to a gear train lead to the first pressure roller 105 from the load torque generation member 131 in this embodiment. In addition, in each of the paths, the load torque input gear (a first gear) 141 is disposed in the first path, and is connected to the load torque transmission gear 140. In addition, the load torque transmission gear (a second gear) 142 is disposed in the second path, and is connected to the load torque transmission gear 140.

According to the configuration described above, both the first drive roller 104 and the first pressure roller 105 receive the load torque generated by the load torque generation member 131 so that it is possible to apply a frictional load to the front and rear of the sheet P.

FIG. 6 is a flowchart illustrating a drive control according to the present embodiment, and FIG. 5 is a block diagram illustrating a drive control according to the present embodiment. FIGS. 7A and 7B are front cross-sectional views illustrating the sheet tensioning conveyance device 101 for describing a drive control according to the present embodiment. FIG. 7A is a front cross-sectional view illustrating the operation at timing 0 to X msec after the sheet sensor is turned on, and FIG. 7B is a front cross-sectional view illustrating the operation at timing X msec after the sheet sensor is turned on.

A description will be made for a flowchart of FIG. 6. When a sheet-passing job signal 51 of FIG. 6 is input to an input terminal of the CPU (controller) (S5-1), the drive motor M is turned on (S5-2). When the drive motor M is turned on, the electromagnetic clutch CL is also turned on at the same time to start a sheet-passing operation (S5-3). As a result, a driving force of the drive motor M is transmitted to the drive gears 154, 159, 161 and 162 through the drive transmission gears. In this manner, all the conveying rollers, that is, the first drive roller 104, the first pressure roller 105, the second drive roller 106 and the second pressure roller 107 are rotated.

Then, the sheet P is guided to the inlet guide 121 in the sheet tensioning conveyance device 101, and when a signal of turning on the sheet sensor 103 is recognized (S5-4), the electromagnetic clutch CL is turned off after X msec (S5-5). The value “X” is set to time right after a leading end of the sheet P is nipped in the nip portion of the second pair of rollers after the sheet sensor 103 is turned on, and is determined based on a conveyance speed of the sheet P and a distance from the sheet sensor 103 to the nip portion of the second pair of rollers. That is, the controller determines that the a sheet is nipped in the nip portion of the second pair of rollers based on a predetermined distance from the sheet sensor 103 to the nip portion of the second pair of rollers and the conveyance speed of the sheet P. In this embodiment, since the conveyance speed of the sheet P is 300 mm/s, and the distance from the sheet sensor 103 to the nip portion of the second pair of rollers is 45 mm, it is set as X=160 msec.

When the sheet sensor 103 is turned on, and the electromagnetic clutch CL is turned off after X msec, the transmission of driving force to the first drive roller 104 and the first pressure roller 105 are released. That is, as illustrated in FIG. 7A, the electromagnetic clutch CL is turned on when 0 to X msec elapses after the sheet sensor is turned on and accordingly, the first drive roller 104 and the first pressure roller 105 receive the driving force to convey the sheet P. Then, as illustrated in FIG. 7B, a point of time in which X msec elapses after the sheet sensor is turned on is the time right after the leading end of the sheet P reaches the nip portion of the second pair of rollers, and accordingly, the sheet P is conveyed by driving the second drive roller 106 and the second pressure roller 107. At the same time, the electromagnetic clutch CL is turned off, and the driving force is not transmitted to the first drive roller 104 and the first pressure roller 105 so that the first pair of rollers is drivenly rotated.

In addition, since the load portion having the load torque generation member 131 and the load torque transmission gear 140 as described above is connected to the first drive roller 104 and the first pressure roller 105, a torque load is generated so as to rotate the first drive roller 104 and the first pressure roller 105.

In the present invention, the tension load generated by the first drive roller 104 and the first pressure roller 105 is used to set the load torque of the load portion and a gear ratio of each transmission gear such that a sum of tension applied to the front and rear surfaces of the sheet P becomes a predetermined tension. For example, the load torque of the load portion and the gear ratio of each transmission gear are set such that a tension applied to the front surface of the sheet P is about 29 N (3 kgf), a tension applied to the rear surface of the sheet P is about 29 N (3 kgf) and the sum thereof is about 58 N (6 kgf).

As a result, in FIG. 7B, the sheet P is nipped by the first drive roller 104 and the first pressure roller 105, and the total tension load of about 58 N (6 kgf) is applied to both the front and rear of the sheet P in the upstream side of the conveying direction. Further, both the front and rear of the sheet P are conveyed by a greater fictional driving force than the tension load in the downstream side of the conveying direction by the second drive roller 106 and the second pressure roller 107 in a state of being applied with the tension load. Thus, the sheet P is conveyed while a tension (tensile strength in the conveying direction) is generated between the first pair of rollers and the second pair of rollers.

In addition, since the tension affects evenly the front and rear of the sheet P, the sheet P is pulled in the conveying direction. That is, it is possible to prevent a difference in elongation of the front and rear of the sheet P in the conveying direction between the sheet P before passing through the tensioning conveyance device 101 and the sheet P after passing through the tensioning conveyance device 101. Thus, it is possible to further reduce a curl or corrugation caused by the expansion and contraction of the front and rear of the sheet P.

In addition, in the present embodiment, each nip portion of the first pair of rollers and the second pair of rollers has a width (length L1) of 100 mm in the sheet-passing center portion of the sheet as illustrated in FIG. 8. Accordingly, it is configured such that a tension force (tensile strength) of about 58 N (6 kgf) is applied only to the widthwise center portion of the sheet P from a leading end to a trailing end. Then, when the sheet-passing operation is terminated, the drive motor M is turned off (S5-6), and the process is terminated (S5-7). The above-described flow is repeated in the second and subsequent sheets.

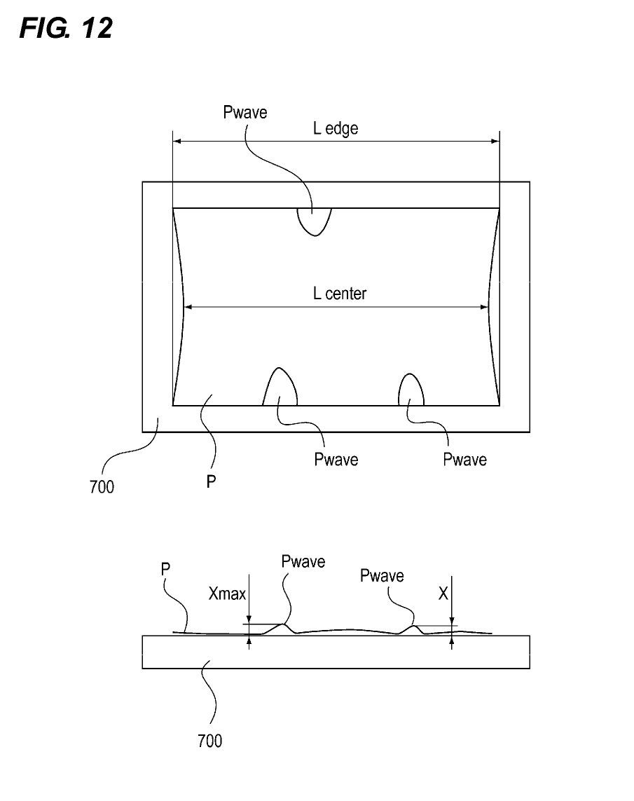

A description will be made for a shape characteristic of a curl or an edge corrugation generated in the sheet P and a measurement method with reference to FIG. 12. The corrugation is measured in a sated where the sheet P is loaded on a measurement table 700. Here, an edge length of the sheet P in the sheet conveying direction is denoted by “L edge [mm]”, and a center length thereof is denoted by “L center [mm]”.

In addition, a wave shape Pwave generated in the upper or lower side of the sheet P illustrated in FIG. 12, that is, the edge of the width direction perpendicular to the conveying direction will be referred to as the edge corrugation. Further, the largest gap X max of gaps from the measurement table 700 is set as a corrugation amount as an evaluation target.

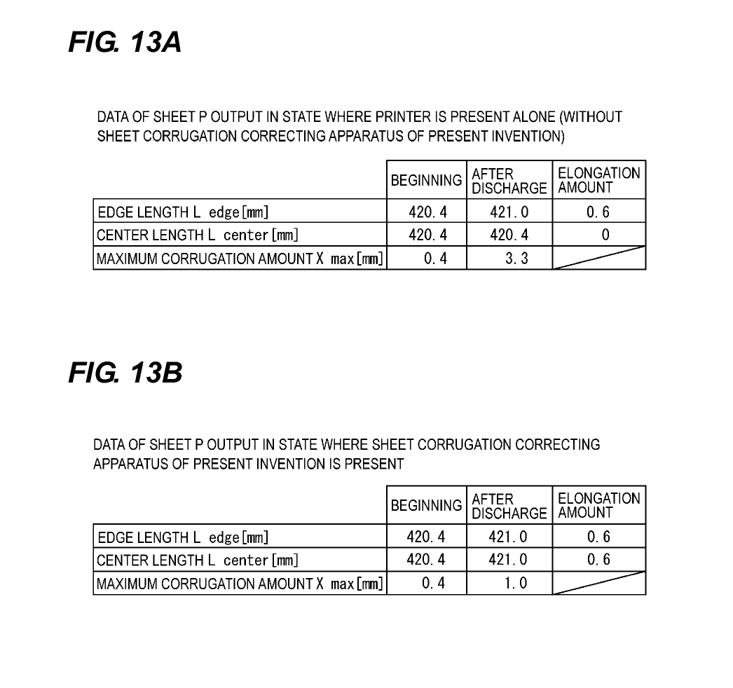

FIGS. 13A and 13B illustrate a result of the experiment for confirming the effect of the tensioning conveyance device 101 according to the present embodiment conducted by the inventors. FIG. 13A describes the edge length L edge [mm], the center length L center [mm], and the maximum corrugation amount X max [mm] of the sheet P output only using the printer without using the sheet corrugation correcting device 201 of the present invention. FIG. 13B describes the edge length L edge [mm], the center length L center [mm], and the maximum corrugation amount X max [mm] of the sheet P right after the corrugation correction processing at a conveyance speed of 300 mm/s using the sheet corrugation correcting device 201 of the present invention, the sheet P each immediately after being printed out from the printer, and after several minutes has elapsed from then.

As illustrated in FIG. 13B, in the case where the sheet has passed through the sheet corrugation correcting device 201 (sheet-passing at 300 mm/s), an elongation amount of the center length L center right after being left for one day after the sheet P has passed through the sheet corrugation correcting device 201 is 0.6 mm. On the contrary, an elongation amount of the edge length L edge is 0.6 mm, so that a difference between the edge length and the center length is 0 mm. That is, the center portion of the sheet P is pulled according to the effect of the tensioning conveyance device of the present invention so that each elongation amount of the edge and center become approximately equal as a result. As a result the maximum corrugation amount is improved to be 1.0 mm, that is, reduced to about ⅓ as in FIG. 13B relative to 3.3 mm as in FIG. 13A as the edge length and center length of the sheet become equal. In the present embodiment, the moisture amount applied to a sheet for exerting the above-described effect is set to around 7% in any type of sheet.

As described above, it is possible to correct the corrugation by reducing the difference between the edge length and the center length of the sheet by pulling the center portion of the sheet while the sheet passes through the tensioning conveyance device after being moistened at a predetermined moisture amount or higher.

In this embodiment, the elastic rubbers 105b and 107b of the first pressure roller 105 and the second pressure roller 107, respectively, have a straight shape having a width (length L in FIGS. 7A and 7B) of 100 mm. However, the elastic rubber may have a tapered shape or a crown shape such as a parabolic shape. That is, at least a part of the outer diameters of the elastic rubbers 105b and 107b of the first pressure roller 105 and the second pressure roller 107, respectively, may change in a rotational axis direction, and the center portion of the rotational axis direction may be larger than the edge portion of the rotational axis direction.

In FIG. 1, the conveyance path from the pair of discharge rollers 540 of the printer 500 to the pair of entrance rollers 541 of the sheet corrugation correcting device 201 has a height T1 with respect to an apparatus grounding plane Z. Similarly, a discharge port from a conveying roller 545 to the sheet corrugation correcting device 201 has a height T2 with respect to the apparatus grounding plane Z.

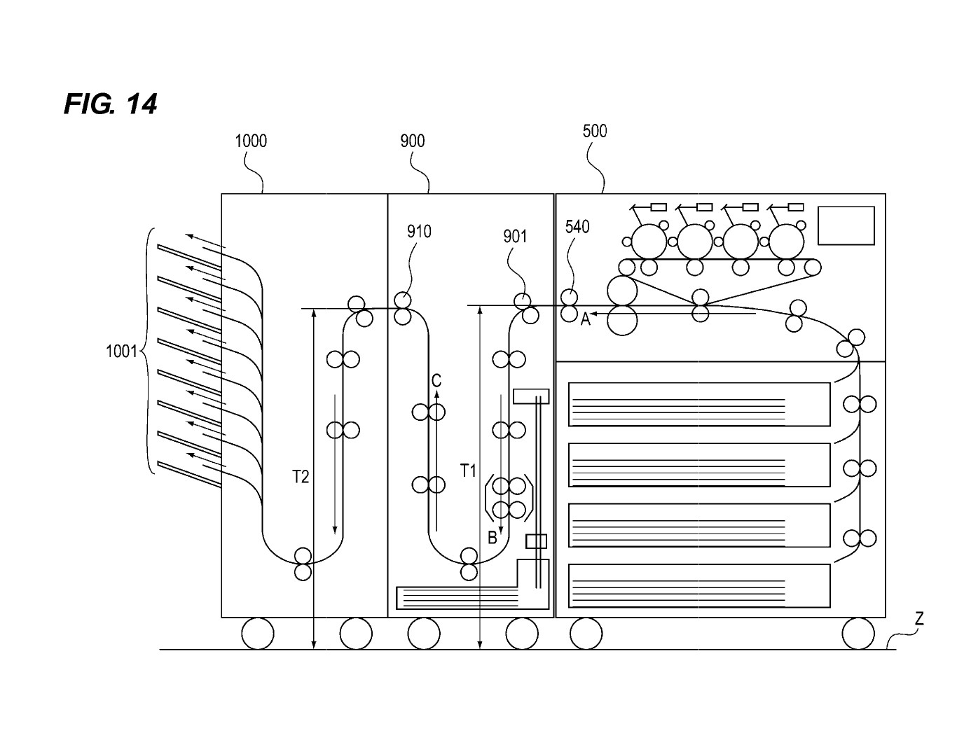

FIG. 14 illustrates an example in which a sorter device 400 serving a function of sorting sheets into a plurality of sort trays 401 is connected to the further downstream side of the sheet corrugation correcting device 201. Here, the height T1 of the conveyance path from the pair of discharge rollers 540 of the printer 500 to the pair of entrance rollers 541 of the sheet corrugation correcting device 201 with respect to the apparatus grounding plane Z is set to be equal to the height T2 from a conveying roller 545 of the sheet corrugation correcting device 201 to the discharge port. Accordingly, versatility may be provided in a connection and access function of each device. That is, it is possible to directly connect the sorter device 400 without disposing the sheet corrugation correcting device 201 in the downstream side of the color electrophotographic printer 500. Accordingly, it is possible to obtain functionality as the entire system including the color electrophotographic printer 500 or the sheet corrugation correcting device 201.

As illustrated in FIGS. 1 and 14, the sheet corrugation correcting device 201 is provided with an approximately vertically downward conveyance path (arrow direction B) in the conveyance path of the sheet P. In addition, the sheet moistening device 202 serving as a moistening portion (moisture application portion) for changing a moisture amount of the sheet P is arranged in the approximately vertically downward conveyance path. Further, the sheet tensioning conveyance device 101 serving as a tensile strength application portion to a sheet P is arranged in the downstream side (lower side) therefrom. Accordingly, it is possible to efficiently arrange each device within a range of the height T1 with respect to the apparatus grounding plane Z in the conveyance path from the pair of discharge rollers 540 of the printer 500 to the pair of entrance rollers 541 of the sheet corrugation correcting device 201 so as to obtain functionality as the entire system.

According to the present embodiment described above, it is possible to correct align the center length of the sheet elongated in the conveying direction with the edge length by allowing the center length and edge length of the sheet to be equal by elongating the widthwise center portion of the sheet in the conveying direction so that it is possible to correct the corrugation in the end portion.

In addition, the tension affects evenly to the front and rear of the sheet so that it is possible to prevent the difference in each elongation of the front and rear of the sheet in the conveying direction caused by pulling the sheet in the conveying direction. Thus, it is possible to further reduce the curl or corrugation caused by the expansion and contraction of the front and rear of the sheet P.

Further, it is possible to correct the corrugation by adding the moisture on the sheet, separating the hydrogen bonding between fibers, facilitating expansion and contraction of the sheet according to the tension load to the center portion of the sheet to facilitate the equalization of the length between the edge portion and center portion of the sheet.

### Second Embodiment

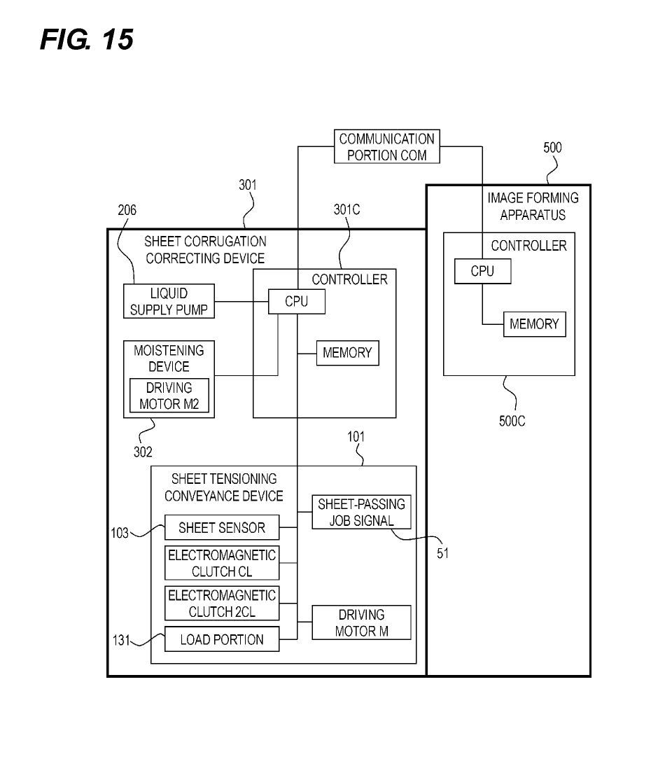

A description will be made regarding on a configuration surrounding the sheet corrugation correcting device 301, the sheet moistening device 302 and the load torque generation member 131 of the sheet tensioning conveyance device 101 with reference to FIGS. 15 to 20.

Since the configuration and operation excluding those surrounding the sheet moistening device 302 and the load torque generation member 131 of the sheet tensioning conveyance device 101 are the same as in the first embodiment, the description thereof will be omitted. Further, the moistening liquid L and the sheet P are the same as in the first embodiment, so that the same reference numerals are given.

FIG. 15 is a block diagram illustrating a control relationship in the entire image forming apparatus 500 and a sheet corrugation correcting device 301.

In the sheet corrugation correcting device 301 according to the present embodiment, the spay sheet moistening device 202 according to the first embodiment is substituted with a roller-type sheet moistening device 302. However, they have the same in terms of moistening of the sheet P. That is, the configuration in which the moisture is added to the sheet by spraying the moistening liquid is exemplified as the moistening portion in the first embodiment, however, a configuration in which moisture is added to the sheet using a roller rotated while the moistening liquid is held in a surface layer is exemplified in the present embodiment.

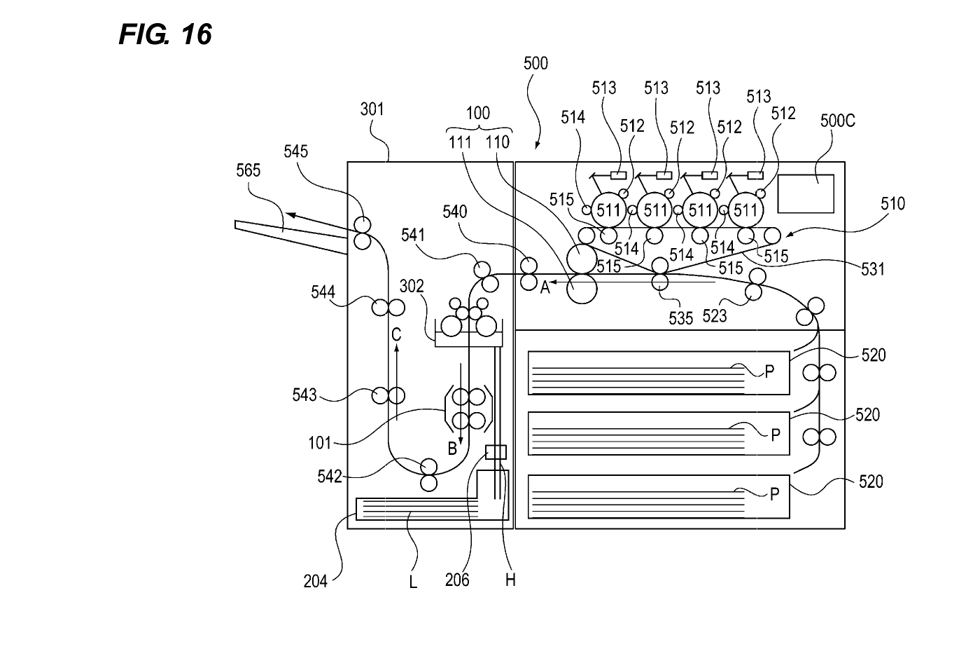

The sheet P fed in a direction B of FIG. 16 similarly to the direction B of FIG. 1 is guided to a moistening inlet guide 310 illustrated in FIGS. 13A and 13B, fed to a nip portion of a pair of moistening rollers 305 and 306, and then moistened by the moistening liquid L transferred to the surface thereof.

The pair of moistening rollers 305 and 306 is an elastic roller obtained by forming a solid rubber layer made of nitrile butadiene rubber (NBR), silicon, or the like as a main component on a surface of a core made of a metal rigid body such as stainless steel.

Liquid supply rollers 307 and 308 are liquid supply members for sequentially supplying the moistening liquid L. The liquid supply rollers 307 and 308 are elastic rollers having a solid rubber layer mainly made of a material, such as NBR, having a hydrophilic surface capable of holding a moistening liquid L on a core surface made of a metal rigid body such as stainless steel. The solid rubber layer may be made of metal or resin subjected to hydrophilic treatment.

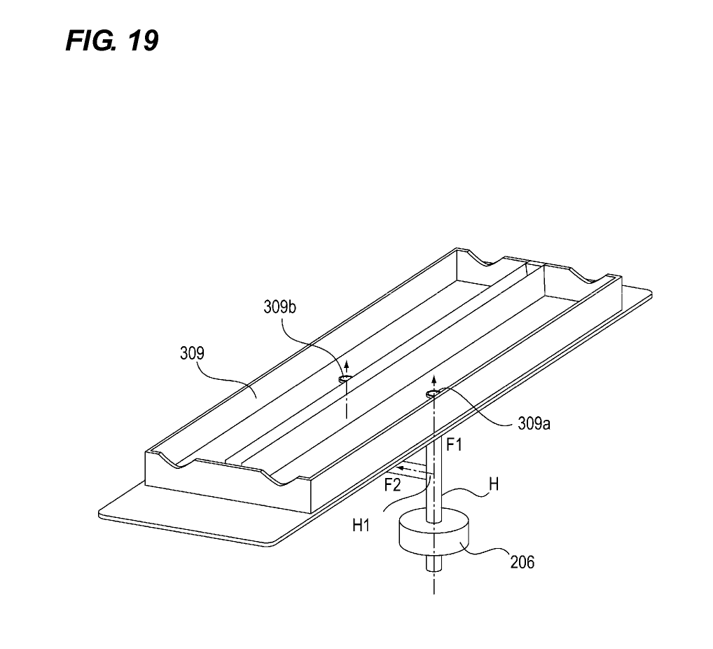

The reservoir 204 illustrated in FIG. 16 is connected to liquid supply baths 309 and 309 provided in the sheet moistening device 302 via an intermediate pump 206, as illustrated in FIG. 19.

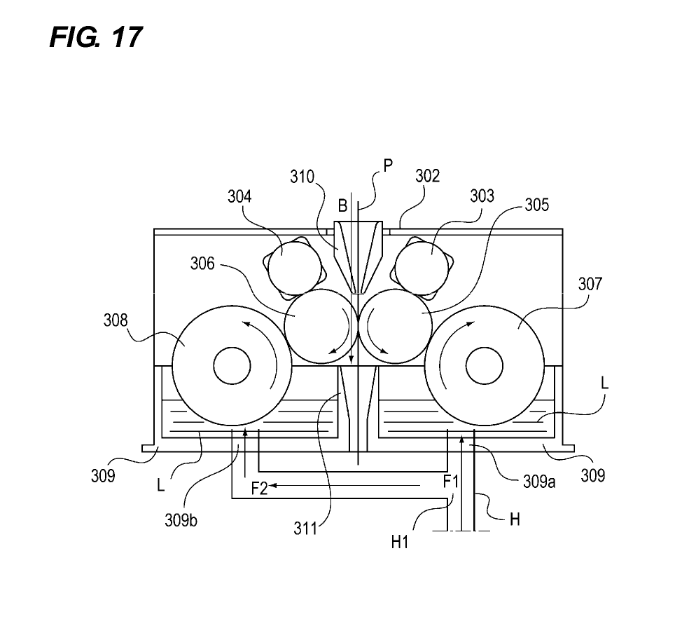

The moistening liquid L stored in the liquid supply pipe H is occasionally branched and supplied in arrow directions F1 and F2 indicated in FIGS. 17 and 19 to the liquid supply baths 309 and 309 via a branching portion H1 provided in the liquid supply pipe H using a pump 206. The moistening liquid L contains water as a main component. Pipes branching from the liquid supply pipe H are connected to liquid supply ports 309a and 309b provided right below the liquid supply rollers 307 and 308 provided in the bottoms of the liquid supply baths 309 and 309, respectively.

The moistening liquid L supplied by the pump 206 and stored in the bottom of the liquid supply baths 309 and 309 via the liquid supply ports 309a and 309b is pumped up by the rotation of the liquid supply rollers 307 and 308 of which lower part is immersed as illustrated in FIG. 17. The moistening liquid L is pumped up by effect of viscosity of the moistening liquid L itself, a surface tension, wettability of a rubber surface layer of the liquid supply rollers 307 and 308.

The moistening liquid L held in the surface layers of the liquid supply rollers 307 and 308 is further transferred onto the surface layer of each of the moistening rollers 305 and 306 and is squeezed from each scraping roller 303 and 304. Therefore, the moistening liquid L is transferred onto each of the moistening rollers 305 and 306 while uniformity is maintained. The scraping rollers 303 and 304 are made of a material obtained by performing a hard chrome plating treatment on a surface of, for example, stainless steel or iron steel.

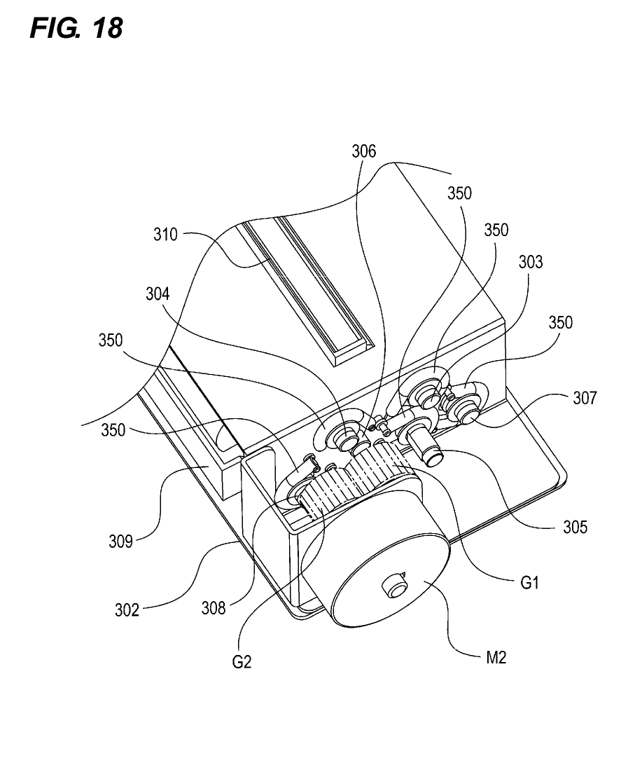

As illustrated in FIG. 18, a drive input gear G1 for inputting a driving force is fixed to one end of the moistening roller 306. A drive motor M2 is a drive source for rotatably driving the drive input gear G1 and is fixed to the same shaft as that of the drive gear G2. As the drive input gear G1 and the drive gear G2 are engaged with each other, a driving force of the drive motor M2 is transmitted to the drive input gear G1.

The moistening roller 305, the liquid supply roller 308 and the scraping roller 304 are pressed to the moistening roller 306 using a pressure spring 350 obtained by bending a tension coil spring in a U-shape as illustrated in FIG. 18. Further, the liquid supply roller 307 and the scraping roller 303 are pressed to the moistening roller 305 using the pressure spring 350 obtained by bending a tension coil spring in a U-shape as illustrated in FIG. 18.

As described above, when the driving force of the drive motor M2 is transmitted to the drive input gear G1, the moistening roller 306 is rotationally driven. Then, except for the moistening roller 306, all of the moistening roller 305, the liquid supply rollers 307 and 308, and the scraping rollers 303 and 304 are drivenly rotated.

The sheet P entering the nip portion of the pair of moistening rollers 305 and 306 and being moistened by transferring the moistening liquid L onto the surface thereof is guided to a moisture discharge guide 311. Then, the sheet P is discharged from the sheet moistening device 302 and thereafter, is conveyed to the sheet tensioning conveyance device 101 as similarly in the first embodiment.

In this embodiment, a degree of the sheet corrugation correction is also similar to that of the first embodiment in a case where a moisture amount applied to the sheet P by the sheet moistening device 302 is set to around 7% as the case of the first embodiment.

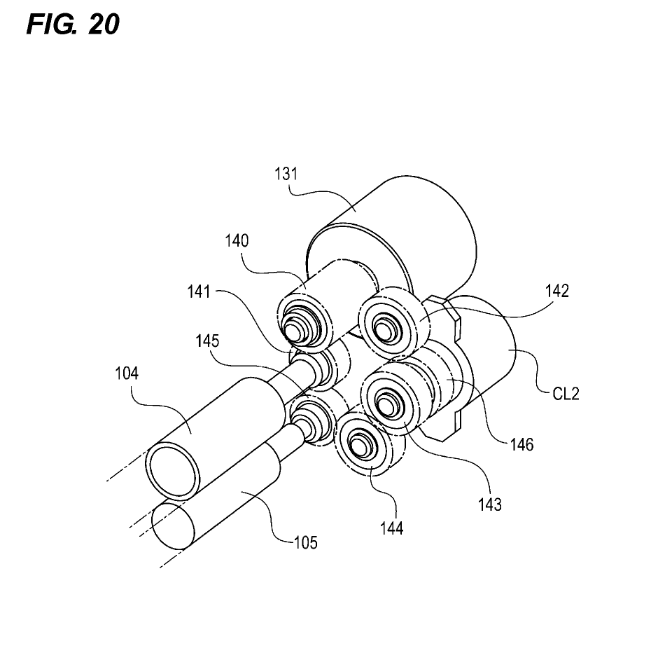

FIG. 20 is a deviated view illustrating the torque loading mechanism of the first drive roller 104 and the first pressure roller 105. Incidentally, FIG. 20 illustrates the torque loading mechanism provided at each other end of the first drive roller 104 and the first pressure roller 105 with respect to the driving mechanism provided in each one end of the first drive roller 104 and the first pressure roller 105.

As illustrated in FIG. 20, the load torque input gear 141 is fixed to the end of the first drive roller 104, and is connected to the load torque generation member 131 such as an electromagnetic brake through the load torque transmission gear 140, which is the same as in the first embodiment described above.

Meanwhile, the load torque generation member 131 such as the electromagnetic brake is connected to the first pressure roller 105. The load torque input gear 145 is fixed to the end of the first pressure roller 105. The load torque transmission gear 140 is fixed to the load torque generation member 131. The load torque input gear 145 and the load torque transmission gear 140 are connected via the load torque transmission gears 144 and 143, the clutch input gear 146 of the electromagnetic clutch CL2 as a load releasing portion, and the load torque transmission gears 142.

The clutch input gear 146 is fixed to the electromagnetic clutch CL2. Further, the clutch input gear 146 and the load torque transmission gear 143 as a clutch output gear are connected and the load torque is transmitted when electricity flows through the electromagnetic clutch CL2 and the load torque is applied also to the first pressure roller 105.

If electricity does not flow to the electromagnetic clutch CL2, the load torque is not transmitted since the connection between the clutch input gear 146 and the load torque transmission gear 143 is released so that the load torque is not applied to the first pressure roller 105 either.

Accordingly, the load torque according to the load torque generation member 131 is constantly applied to the first drive roller 104.

However, it is possible to select whether or not the load torque according to the load torque generation member 131 is applied to the first pressure roller 105 by switching the flow of electricity to the electromagnetic clutch CL2.

In the state where electricity flows to the electromagnetic clutch CL2, the sheet P is nipped by the first drive roller 104 and the first pressure roller 105, and the front and rear of the sheet is applied with the tension load in the upstream side of the conveying direction so that it is possible to obtain the same effect as in the first embodiment described above.

However, in a state where electricity does not flow to the electromagnetic clutch CL2, the tension load is applied only to the front surface of the sheet P by the first drive roller 104 while the sheet P is nipped by the first drive roller 104 and the first pressure roller 105, different from the case in the first embodiment.

In the present embodiment, the load torque of the load torque generation member 131 and the gear ratio of each transmission gear are set such that each of the tension load according to the first drive roller 104 and the first pressure roller 105 is applied to both the front and rear of the sheet P in the state where electricity flows to the electromagnetic clutch CL2. For example, the load torque of the load torque generation member 131 and the gear ratio of each transmission gear are set such that a tension applied to the front surface of the sheet P is about 29 N (3 kgf), a tension applied to the rear surface of the sheet P is about 29 N (3 kgf) and the sum thereof is about 58 N (6 kgf).

Meanwhile, the tension load according to the first drive roller 104 and the first pressure roller 105 is applied to one surface of the sheet P in the state where electricity does not flow to the electromagnetic clutch CL2. For example, a tension applied to the front surface of the sheet P is about 29 N (3 kgf), a tension applied to the rear surface of the sheet P is about 0 N (0 kgf) and the sum thereof is about 29 N (3 kgf).

The turning on and off of electromagnetic clutch CL2 is immediately set depending on the information obtained by a CPU 301C of FIG. 15 through the communication portion COM regarding on an image to be formed on the sheet P from the image forming apparatus 500. For example, the electromagnetic clutch CL2 is switchably turned on and off depending on an average density difference (difference in an application amount of a toner) of images of front and rear surfaces of the sheet P. In a case where an average density of the front surface of the sheet and an average density of the rear surface are different from each other, a difference in the moisture amount according to the sheet moistening device 302 is generated between the front surface and the rear surface. This is because the moistening of the sheet is sufficiently performed in a case where the average density is low with respect to a case where the average density is high so that the toner inhibits the sheet from absorbing moisture, thereby reducing the moisture amount to the sheet. Accordingly, in the case where the average density of the front surface is higher than or equal to a predetermined value compared to that of the rear surface, the difference in the moisture amount according to the sheet moistening device 302 is generated between the front and rear of the sheet. Fibers inside the sheet P at the rear surface side in which the moisture amount is relatively high elongates to cause a curl (upstream curl) in the front surface side of the sheet P.

The flow of electricity to the electromagnetic clutch CL2 is cut and the tension is applied only to the front surface of the sheet P so as to correct the upstream curl simultaneously while the tension is applied to the sheet P. Accordingly, mainly the front surface of the sheet is only elongated to simultaneously correct the upstream curl.

Similarly, if an additional electromagnetic clutch is disposed between the load torque input gear 141 and the load torque transmission gear 140 illustrated in FIG. 20, the torque load to the first drive roller 104 may be also simultaneously controlled. In other words, reversely to the upstream curl to the front surface side of the sheet described above, it is possible to simultaneously correct a curl (downstream curl) to the rear surface side of the sheet P.

Incidentally, the treatment performed based on the average density of an image is exemplified as an example where an upstream curl (or a downstream curl) is generated, but it is not limited thereto. In a case where the upstream curl (or the downstream curl) is generated due to another condition, the electromagnetic clutch may be controlled so as to correct such a curl.

### Third Embodiment

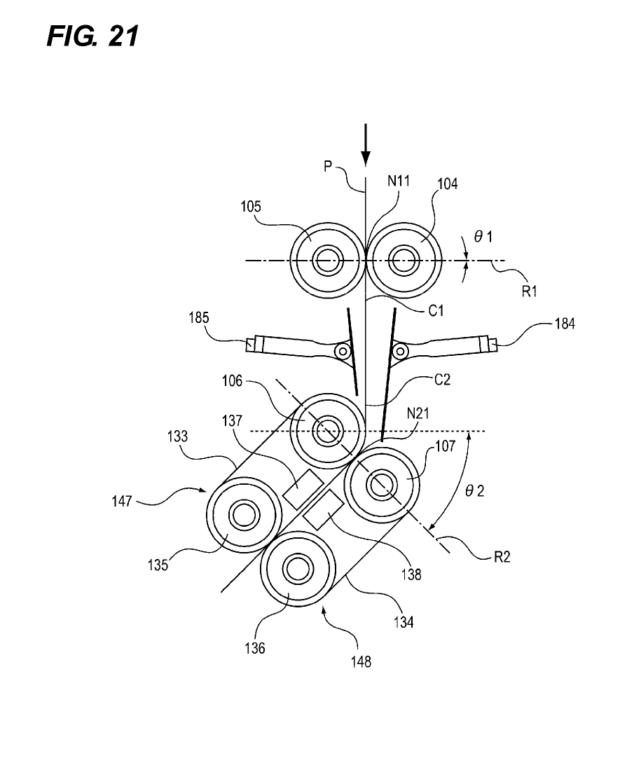

A third embodiment will be described with reference to FIG. 21. In the present embodiment, the same configuration is employed other than a point in which the tensioning conveyance device is only changed in the sheet processing apparatus according to the first embodiment. Accordingly, the description except for the tensioning conveyance device will be omitted.

A point different from the first embodiment is that a pair of rotating members in the downstream side of the conveying direction of the sheet P is configured by a pair of belts. As illustrated in FIG. 21, it is configured such that the sheet P is wound around a second drive belt 147 and is pulled to obtain elongation of the sheet.

The pair of belts includes the second drive belt 147 and a second pressure belt 148. The second drive belt 147 includes a second drive endless belt 133, the second drive roller 106, a second drive side endless belt roller 135 and a second drive side pressure pad 137. The second pressure belt 148 includes a second pressure endless belt 134, the second pressure roller 107, a second pressure side endless belt roller 136 and a second pressure side pressure pad 138. Other than these, the pair of rollers formed of the first drive roller 104 and the first pressure roller 105 as the pair of rotating members in the upstream side corresponds to the configuration in the first embodiment, and thus, the detailed description thereof will be omitted.

When the sheet P is conveyed to the tensioning conveyance device illustrated in FIG. 21, the sheet P passes through a first nip portion N11 formed by the first drive roller 104 and the first pressure roller 105. Then, the sheet P is guided to sheet guides 184 and 185, and passes through a second nip portion N12 formed by the second drive belt 147 and the second pressure belt 148. When the sheet P simultaneously passes through the first nip portion N11 and the second nip portion N12, a tension force is applied with respect to the sheet P. When the tension force is applied to the sheet P, the sheet P forms a conveyance path C1 in the downstream side than the first nip portion N11. In addition, the sheet P forms a conveyance path C2 in the upstream side than the second nip portion N12. In FIG. 21, the conveyance path C1 and the conveyance path C2 are on the same straight line. In the conveyance path C2, the sheet P is wound around the second drive belt 147 at a second winding angle θ2.

At this time, a tensile stress and a bending stress is simultaneously applied to the sheet P as the sheet P is wound around the second drive belt 147 at the second winding angle θ2. In this manner, the sheet P is pulled while being applied with the bending stress so that it is possible to apply the tensile strength to the sheet efficiently compare to a case where the sheet is straightly pulled in a simple manner. A plastic elongation is generated with respect to the sheet P by allowing the tensile stress and the bending stress to exceed a yield stress of the sheet P.

Incidentally, a magnitude relationship between θ1 and θ2 is not limited to the present embodiment, and may be configured such that θ1>θ2, θ1<θ2, or θ1≈θ2.

FIG. 21 illustrates the configuration in which the sheet P is pulled while being bent. A straight line connecting a rotational center of the first drive roller 104 and a rotational center of the first pressure roller 105 is defined as a roller center line R1. Further, a straight line connecting a rotational center of the second drive roller 106 and a rotational center of the second pressure roller 107 is defined as a roller center line R2.

The second pair of belts 147 and 148 is configured to have inclination with respect to the first pair of rollers 104 and 105 disposed perpendicular to the conveyance path C2. That is, the center line R2 is inclined and is not parallel with respect to the center line R1.

It is possible to obtain a configuration in which the sheet P is wound around at least any one of the first pair of rollers (first pair of rotating members) and the second pair of belts (second pair of rotating members) among the plural pairs of rotating members by configuring the center line R1 and the center line R2 not to be parallel to each other.

Incidentally, in a case where the first pair of rotating members is the pair of belts, a line connecting rotational centers of a pair of rollers in the downstream side of the sheet conveying direction among rollers stretching the belt is defined as the center line R1. Meanwhile, in a case where the second pair of rotating members is the pair of belts, a line connecting rotational centers of a pair of rollers in the upstream side of the sheet conveying direction among the rollers stretching the belt is defined as the center line R2.

In FIG. 21, in the case where the tension is applied to the sheet P while the sheet P is wound around the second drive belt 147, it is necessary to set a pressing force between the nip portions of the pair of rollers to be greater to some extent as described in the first embodiment.

In the present embodiment, the second drive roller 106 stretching the second drive belt 147 serves as a fixing roller which is fixed to a side plate and only capable of rotating. In this manner, it is configured such that the pressing force between the nip portions of the pair of belts is not small.

In this manner, even in the case where the pair of belts is used as the pair of rotating members instead of the pair of rollers, the first drive roller 104 and the first pressure roller 105 are connected to the load portion having the load torque generation member 131 and the load torque transmission gear 140 as illustrated in FIG. 9, and accordingly, it is possible to obtain the same effect as in the first embodiment. In addition, in the configuration of the first and second embodiments, the same effect may be obtained even with the configuration obtained by substituting the pair of rollers with the pair of belts.

Incidentally, in the third embodiment, the pair of belts is used as the second pair of rotating members in the downstream side of the conveying direction of the sheet P, but it is not limited thereto. The pair of rotating members in the upstream side of the conveying direction of the sheet P may be the pair of belts.

As described above, even in the third embodiment, it is possible to obtain the effect of efficiently pulling the sheet P similarly to the first and second embodiments.

In addition, it is possible to improve a conveying force by the configuration of substituting the pair of rollers in the first and second embodiments with the pair of belts.

### Other Embodiment

In the embodiments described above, the detachable sheet conveying apparatus has been exemplified as an optional external device with respect to the image forming apparatus, but the present invention is not limited thereto. For example, a sheet conveying apparatus integrally provided with the image forming apparatus may be employed, and the present invention is applied to such a sheet conveying apparatus in order to obtain the same effect as the entire image forming apparatus. In addition, the configuration in which the control portion included in the sheet conveying apparatus is controlled by the control portion included in the image forming apparatus so as to control the operation of the sheet conveying apparatus is exemplified. However, it may be configured such that the sheet conveying apparatus has a control portion and the operation thereof is controlled by such a control portion. Alternatively, it may be configured such that the operation of the sheet conveying apparatus is controlled by a control portion included in the image forming apparatus. It is possible to obtain the same effect also with such a configuration.

In addition, in the embodiments described above, the printer has been exemplified as the image forming apparatus, but the present invention is not limited thereto. For example, it may be applied to other image forming apparatuses such as a copying machine, a facsimile, or a multi-function peripheral having such functionalities. In addition, the image forming apparatus has been exemplified in which the intermediate transfer member is used, and toner images of each color is transferred onto the intermediate transfer member in a sequentially superimposed manner so that the toner images born in the intermediate transfer member are collectively transferred onto the sheet, but the present invention is not limited thereto. For example, an image forming apparatus may be used in which a sheet bearing member is used, and toner images of each color are transferred onto a sheet born in the sheet bearing member in a sequentially superimposed manner. It is possible to obtain similar effects when the present invention is applied to the image forming apparatus or the sheet conveying apparatus included in the image forming apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-093707, filed Apr. 30, 2014, No. 2015-047167, filed Mar. 10, 2015, which are hereby incorporated by reference herein in their entirety.

What is claimed is:

1. A sheet conveying apparatus comprising:
a first pair of rotating members which includes a first rotating member and a second rotating member and conveys a sheet;
a second pair of rotating members which is provided in a downstream side of the first pair of rotating members in a sheet conveying direction and conveys a sheet;
a load portion capable of applying a load to rotation of the first pair of rotating members so as to generate a tensile stress onto the sheet when the sheet is nipped by the first pair of rotating members and the second pair of rotating members; and
a load transmission path which transmits a load torque according to the load portion to the first rotating member and the second rotating member.

2. The sheet conveying apparatus according to claim 1,
wherein the load transmission path includes a first path between the load portion and the first rotating member, and a second path between the load portion and the second rotating member.

3. The sheet conveying apparatus according to claim 2,
wherein the load portion includes a load torque generation member which generates the load torque, and a branching gear which branches the load torque into the first path and the second path.

4. The sheet conveying apparatus according to claim 3,
wherein a first gear provided in the first path and connected to the branching gear, and a second gear provided in the second path and connected to the branching gear are provided.

5. The sheet conveying apparatus according to claim 1,
wherein a load releasing portion is provided which releases the load torque according to the load portion, and the load releasing portion is capable of releasing the load torque transmitted to at least any one of the first rotating member and the second rotating member.

6. The sheet conveying apparatus according to claim 5,
wherein a control portion is provided which controls the release of the load torqued by the load releasing portion depending on the information regarding on a density of the sheet to be conveyed.

7. The sheet conveying apparatus according to claim 6,
wherein, in a case where a density of a first surface of the sheet is higher than or equal to a predetermined value compared to a density of a second surface of the sheet, the control portion controls the load releasing portion to release the load torque of the second rotating member which adjoins the second surface.

8. The sheet conveying apparatus according to claim 5,
wherein the load releasing portion is an electromagnetic clutch.

9. The sheet conveying apparatus according to claim 1,
wherein the first pair of rotating members and the second pair of rotating members apply a tensile strength in the conveying direction to a center portion area in a width direction perpendicular to the conveying direction of the sheet.

10. The sheet conveying apparatus according to claim 1,
wherein a nip formed by the first pair of rotating members is regarded as a first nip portion, a nip formed by the second pair of rotating members is regarded as a second nip portion, and a length of at least any one of the first nip portion and the second nip portion in the width direction perpendicular to the sheet conveying direction is shorter than a length of the sheet to be conveyed.

11. The sheet conveying apparatus according to claim 1,
wherein an outer diameter of at least any one rotating member among the first pair of rotating members and the second pair of rotating members is set such that an outer diameter of a center portion of a rotational axis direction may be larger than an outer diameter of an edge portion of the rotational axis direction.

12. The sheet conveying apparatus according to claim 1,
wherein a moistening portion is provided in the sheet conveying direction so as to moisten the sheet disposed in an upstream of the sheet conveying direction of the first pair of rotating members and the second pair of rotating members.

13. An image forming apparatus comprising:
an image forming portion which forms a toner image on a sheet;
a fixing portion which heats the toner image on the sheet formed by the image forming portion so as to be fixed on the sheet; and
the sheet conveying apparatus which conveys the sheet passing through the fixing portion,
wherein the sheet conveying apparatus includes:
a first pair of rotating members which includes a first rotating member and a second rotating member and conveys the sheet;
a second pair of rotating members which is provided in a downstream side of the first pair of rotating members in a sheet conveying direction and conveys a sheet;
a load portion capable of applying a load to rotation of the first pair of rotating members so as to generate a tensile stress onto the sheet when the sheet is nipped by the first pair of rotating members and the second pair of rotating members; and
a load transmission path which transmits a load torque according to the load portion to the first rotating member and the second rotating member.

14. The image forming apparatus according to claim 13,
wherein the load transmission path includes a first path between the load portion and the first rotating member, and a second path between the load portion and the second rotating member.

15. The image forming apparatus according to claim 14,
wherein the load portion includes a load torque generation member which generates the load torque, and a branching gear which branches the load torque into the first path and the second path.

16. The image forming apparatus according to claim 15,
wherein a first gear provided in the first path and connected to the branching gear, and a second gear provided in the second path and connected to the branching gear are provided.

17. The image forming apparatus according to claim 13,
wherein a load releasing portion is provided which releases the load torque according to the load portion, and the load releasing portion is capable of releasing the load torque transmitted to at least any one of the first rotating member and the second rotating member.

18. The image forming apparatus according to claim 17,
wherein a control portion is provided which controls the release of the load torqued by the load releasing portion depending on the information regarding on a density of the sheet to be conveyed.

19. The image forming apparatus according to claim 18,
wherein, in a case where a density of a first surface of the sheet is higher than or equal to a predetermined value compared to a density of a second surface of the sheet, the control portion controls the load releasing portion to release the load torque of the second rotating member which adjoins the second surface.

20. The image forming apparatus according to claim 17,
wherein the load releasing portion is an electromagnetic clutch.

21. The image forming apparatus according to claim 13,
wherein the first pair of rotating members and the second pair of rotating members apply a tensile strength in the conveying direction to a center portion area in a width direction perpendicular to the conveying direction of the sheet.

22. The image forming apparatus according to claim 13,
wherein a nip formed by the first pair of rotating members is regarded as a first nip portion, a nip formed by the second pair of rotating members is regarded as a second nip portion, and a length of at least any one of the first nip portion and the second nip portion in the width direction perpendicular to the sheet conveying direction is shorter than a length of the sheet to be conveyed.

23. The image forming apparatus according to claim 13,
wherein an outer diameter of at least any one rotating member among the first pair of rotating members and the second pair of rotating members is set such that an outer diameter of a center portion of a rotational axis direction may be larger than an outer diameter of an edge portion of the rotational axis direction.

24. The image forming apparatus according to claim 13,
wherein a moistening portion is provided in the sheet conveying direction so as to moisten the sheet disposed in an upstream of the sheet conveying direction of the first pair of rotating members and the second pair of rotating members.
